(19) United States
(12) Patent Application Publication
(10) Pub. No.: US 2024/0304157 A1
(43) Pub. Date: Sep. 12, 2024

(54) BACKLIGHT CONTROL METHOD, APPARATUS, DEVICE, AND STORAGE MEDIUM

(71) Applicant: Beijing Xianxin Technology Co., Ltd, Beijing (CN)

(72) Inventors: Honam YIM, Beijing (CN); Youngjin LIM, Beijing (CN); Chenghui YAN, Beijing (CN)

(73) Assignee: Beijing Xianxin Technology Co., Ltd, Beijing (CN)

(21) Appl. No.: 18/665,581

(22) Filed: May 16, 2024

Related U.S. Application Data
(63) Continuation of application No. PCT/CN2022/132064, filed on Nov. 15, 2022.

(30) Foreign Application Priority Data
Nov. 16, 2021 (CN) 202111355151.5

(51) Int. Cl. G09G 3/34; G09G 3/36

(52) U.S. Cl. CPC G09G 3/342; G09G 3/36; G09G 2320/0257; G09G 2320/064

(57) ABSTRACT

Provided are a backlight control method, a device, and a storage medium, where the method includes: acquiring a dimming image corresponding to a display frame sent by a controller, the dimming image matching a display image on a liquid crystal panel; splitting, according to the dimming image, one display frame into a plurality of dimming control frames to control LEDs in a backlight module; where an image corresponding to each dimming control frame is composed of a black image and a partial dimming image which are spliced, and in the plurality of dimming control frames, positions of black images move in a preset direction.

This application is a continuation of International Application No. PCT/CN2022/132064, filed on Nov. 15, 2022, which claims priority to Chinese patent application No. 202111355151.5, filed on Nov. 16, 2021. The disclosures of the aforementioned applications are hereby incorporated by reference in their entireties.

### TECHNICAL FIELD

Embodiments of the present application relate to the field of LED display, and in particular to a backlight control method, an apparatus, a device, and a storage medium.

### BACKGROUND

An electronic device with a display function, for example, a liquid crystal display television (LCD TV), etc., may be provided with a backlight module for backlight adjustment on an image displayed on a liquid crystal panel to improve display effects.

The backlight module may be composed of a large number of light emitting diodes (LEDs), and backlight control from the backlight module may be implemented through an LED driver. At present, there is still room for further improvement in data transmission efficiency and backlight effects during a backlight control process.

### SUMMARY

The embodiments of the present application provide a backlight control method, an apparatus, a device, and a storage medium to improve data transmission efficiency and backlight effects during a backlight control process.

In a first aspect, an embodiment of the present application provides a backlight control method, including: acquiring a dimming image corresponding to a display frame sent by a controller, the dimming image matching a display image on a liquid crystal panel; and splitting, according to the dimming image, one display frame into a plurality of dimming control frames to control LEDs in a backlight module; where an image corresponding to each dimming control frame is composed of a black image and a partial dimming image which are spliced, and in the plurality of dimming control frames, positions of black images move in a preset direction.

In one embodiment, the backlight module is divided into a plurality of horizontal areas, and a number of the plurality of horizontal areas is the same as a number of the dimming control frames split from the one display frame; the preset direction is determined by a scanning direction of the liquid crystal panel; in an i-th dimming control frame, an i-th horizontal area is used for displaying a dimming image corresponding to the horizontal area, and remaining horizontal areas are used for displaying a black image; or, in an i-th dimming control frame, an i-th horizontal area is used for displaying a black image, and remaining horizontal areas are used for displaying a corresponding dimming image; where i takes a value from 1 to n, and n is the number of the plurality of horizontal areas.

In one embodiment, the backlight module is controlled by a plurality of LED drivers through pulse width modulation (PWM) signals; and the splitting, according to the dimming image, the one display frame into the plurality of dimming control frames to control the LEDs in the backlight module, includes: in each dimming control frame of the display frame, controlling a PWM signal of an LED driver corresponding to the dimming control frame to be turned off, and controlling PWM signals of remaining LED drivers to be turned on, to control, based on the turned-on PWM signals, a part of the LEDs in the backlight module to display the corresponding dimming image;
where the LED driver corresponding to the dimming control frame is an LED driver corresponding to an area where a black image is located.

In one embodiment, the method further includes: splitting each dimming control frame into a plurality of sub-frames; where in each sub-frame, an image corresponding to the dimming control frame is displayed for a part of time, and an all-black image is displayed for a part of the time.

In one embodiment, the method further includes: when a frequency abnormality of an oscillator in the LED driver or a speed abnormality of receiving data from the controller is detected, splitting at least one most-latter sub-frame among the plurality of sub-frames into a plurality of small sub-frames; where a total length of the small sub-frames is smaller than a total length of the at least one most-latter sub-frame, and a number of sub-frames split into small sub-frames is dynamically adjusted.

In one embodiment, the method further includes: determining a number of small sub-frames split from one sub-frame; and determining, according to the number of the small sub-frames from the splitting and a resolution of a PWM signal corresponding to the sub-frame, resolutions of PWM signals corresponding to the small sub-frames.

In one embodiment, the LED driver has a plurality of output channels, each output channel being used for controlling a plurality of LEDs; and the method further includes: determining phases of PWM signals of the output channels, where phases of output channels corresponding to a same horizontal area are different; and outputting, according to the determined phases, the corresponding PWM signals through the plurality of output channels.

In a second aspect, an embodiment of the present application provides a backlight control method, including: acquiring a dimming image corresponding to a display frame sent by a controller, the dimming image matching a display image on a liquid crystal panel; and splitting the display frame into a plurality of sub-frames, and controlling, according to the plurality of sub-frames, LEDs in a backlight module; where in each sub-frame, the dimming image is displayed for a part of time, and an all-black image is displayed for a part of the time.

In a third aspect, an embodiment of the present application provides a backlight control apparatus, the apparatus including:
a first acquiring module, configured to acquire a dimming image corresponding to a display frame sent by a controller, the dimming image matching a display image on a liquid crystal panel; and
a first controlling module, configured to split, according to the dimming image, one display frame into a plurality of dimming control frames to control LEDs in a backlight module;
where an image corresponding to each dimming control frame is composed of a black image and a partial dimming image which are spliced, and in the plurality of dimming control frames, positions of black images move in a preset direction.

In a fourth aspect, an embodiment of the present application provides a backlight control apparatus, the apparatus including:
a second acquiring module, configured to acquire a dimming image corresponding to a display frame sent by a controller, the dimming image matching a display image on a liquid crystal panel; and
a second controlling module, configured to split the display frame into a plurality of sub-frames, and control, according to the plurality of sub-frames, LEDs in a backlight module; where in each sub-frame, the dimming image is displayed for a part of time, and an all-black image is displayed for a part of the time.

In a fifth aspect, an embodiment of the present application provides an electronic device including an LED driver, a controller, a backlight module and a liquid crystal panel; where the controller is connected to the LED driver, and is configured to determine, according to a display image corresponding to the liquid crystal panel, a corresponding dimming image and send the corresponding dimming image to the LED driver; the backlight module is connected to the LED driver, and is configured to provide backlight brightness for the liquid crystal panel under control of the LED driver; the liquid crystal panel is connected to the controller, and is configured to acquire the display image from the controller and display the display image; and the LED driver is configured to execute any one of the methods described above.

In a sixth aspect, an embodiment of the present application provides a computer readable storage medium, where the computer readable storage medium stores a computer executable instruction which, when executed by a processor, implements any one of the methods described above.

In a seventh aspect, an embodiment of the present application provides a computer program product, including a computer program which, when executed by a processor, implements any one of the methods described above.

### BRIEF DESCRIPTION OF DRAWINGS

In order to more clearly illustrate technical solutions in the embodiments of the present application or prior art, the following will be a brief introduction to drawings which need to be used in descriptions of the embodiments or prior art, and it will be obvious that the drawings in the following description are intended for some embodiments of the present application, and for a person of ordinary skill in the art, other accompanying drawings may be obtained according to these drawings without paying creative labor.

FIG. 1 is a diagram of a principle of backlight control in the prior art.

FIG. 2 is a flow diagram of a backlight control method provided in an embodiment of the present application.

FIG. 3 is a display diagram during a backlight control process provided in an embodiment of the present application.

FIG. 4 is another display diagram of a backlight control process provided in an embodiment of the present application.

FIG. 5 is a control diagram of an LED driver provided in an embodiment of the present application.

FIG. 6 is a timing diagram of an LED driver provided in an embodiment of the present application.

FIG. 7 is another control diagram of an LED driver provided in an embodiment of the present application.

FIG. 8 is another timing diagram of an LED driver provided in an embodiment of the present application.

FIG. 9 is a diagram of an abnormal backlight cycle provided in an embodiment of the present application.

FIG. 10 is another diagram of an abnormal backlight cycle provided in an embodiment of the present application.

FIG. 11 is a diagram of setting a small sub-frame provided in an embodiment of the

present application.

FIG. 12 is another diagram of setting a small sub-frame provided in an embodiment of the present application.

FIG. 13 is yet another diagram of setting a small sub-frame provided in an embodiment of the present application.

FIG. 14 is a diagram of resolutions of a sub-frame and a small sub-frame provided in an embodiment of the present application.

FIG. 15 is another diagram of resolutions of a sub-frame and a small sub-frame provided in an embodiment of the present application.

FIG. 16 is a diagram of a multi-channel output signal provided in an embodiment of the present application.

FIG. 17 is another flow diagram of a backlight control method provided in an embodiment of the present application.

FIG. 18 is a timing diagram of inserting an all-black image provided in an embodiment of the present application.

FIG. 19 is a display diagram of the solution shown in FIG. 18.

FIG. 20 is a diagram of a principle of backlight control provided in an embodiment of the present application.

FIG. 21 is a structural diagram of an electronic device provided in an embodiment of the present application.

### DESCRIPTION OF EMBODIMENTS

In order to make purposes, technical solutions and advantages of the embodiments in the present application clearer, the technical solutions in the embodiments of the present application will be clearly and completely described below in combination with the drawings in the embodiments of the present application. Obviously, the described embodiments are only a part of the embodiments of the present application, not all of the embodiments. Based on the embodiments in the present application, all other embodiments obtained by a person of ordinary skill in the art without creative labor fall within protection scope of the present application.

Terms used in the embodiments of the present application are only for the purpose of describing specific embodiments and are not intended to limit the present application. As used in the embodiments of the present application, singular forms “a”, “an” and “the” are intended to include plural forms as well, unless the context clearly indicates otherwise.

Depending on the context, expressions “if” and “in a case that” as used herein may be interpreted as “when”, “while”, “in response to determining that”, or “in response to detecting that”. Similarly, depending on the context, phrases “if it is determined that” or “if it is detected that (the stated condition or event)” may be interpreted as “when it is determined that”, “in response to determining that”, “when it is detected that (the stated condition or event)”, or “in response to detecting that (the stated condition or event)”.

It should also be noted that terms “include”, “comprise” or any other variations thereof are intended to cover non-exclusive inclusion, so that a product or system including a series of elements includes not only those elements, but also other elements not explicitly listed, or further includes elements which are inherent to such product or system. Without further limitation, elements defined by phrases “include a . . . ” do not exclude existence of other identical elements in a product or system including the elements.

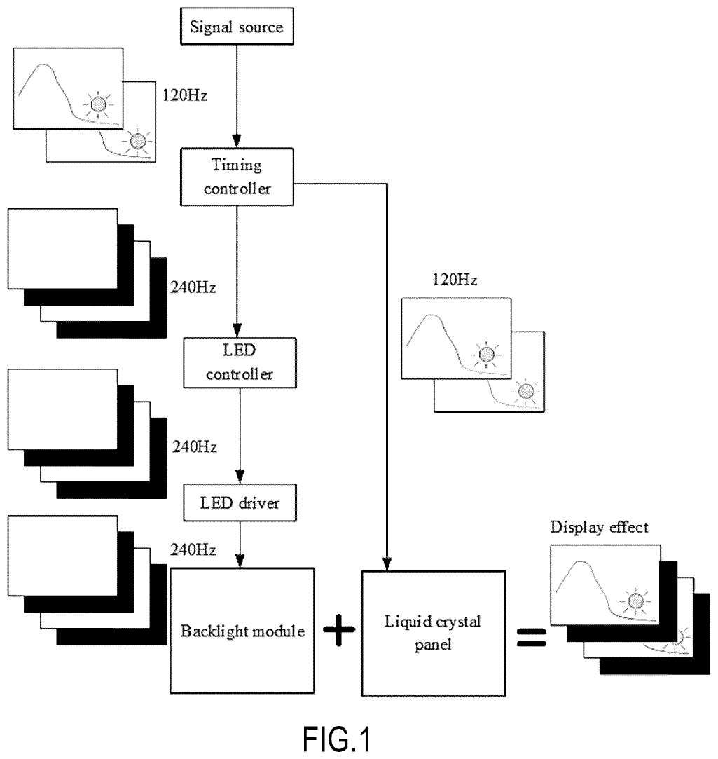

FIG. 1 is a diagram of a principle of backlight control in the prior art. As shown in FIG. 1, a timing controller acquires a display image from a signal source at a frequency of 120 Hz, and sends the display image to a liquid crystal panel at a frequency of 120 Hz, and the liquid crystal panel can display the display image.

At the same time, the timing controller may alternately send a backlight image and a black image to an LED controller at a frequency of 240 Hz, and the LED controller alternately sends the backlight image and the black image to an LED driver at a frequency of 240 Hz. The LED driver controls display brightness of an LED according to the backlight image and the black image, thereby implementing a black frame insertion operation. Display effects of the LED together with display effects of the liquid crystal panel ultimately form visual effects seen by a user.

In the above method, an output frequency of the LED driver is equal to an input frequency of the LED driver. In order to obtain an output frequency of 240 Hz for the LED driver, an input frequency of 240 Hz is required, resulting in the need to transmit data at a relatively high frequency among the timing controller, the LED controller, and the LED driver. Although a black frame insertion operation can be implemented, the frequency required for data transmission is too high, which is not conducive to the control of a display process.

In view of this, an embodiment of the present application provides a backlight control method, where after an LED driver acquires an image sent by a controller, one display frame may be split into a plurality of dimming control frames, and in each dimming control frame, a part of area is controlled to display a black image, and in a plurality of consecutive dimming control frames, positions of black images move in a certain order, so that a black frame insertion operation can be implemented by the LED driver, an amount of data transmitted between the LED driver and the controller is reduced with improved transmission efficiency, and display effects can be effectively improved by continuously adjusting a position of black frame insertion in a scanning manner.

It can be understood that, for the sake of convenience of description, one frame (display frame, dimming control frame, sub-frame, small sub-frame, etc.) in the embodiments of the present application may be used to refer to time corresponding to the one frame (display frame, dimming control frame, sub-frame, small sub-frame, etc.).

For example, splitting one display frame into a plurality of dimming control frames may refer to splitting time corresponding to the one display frame into time corresponding to the plurality of dimming control frames, that is, displaying the plurality of dimming control frames within the time occupied by the one display frame. For example, if one display frame, which is 0.1 seconds, is split into 4 dimming control frames, each dimming control frame occupies 0.025 seconds respectively. Similarly, splitting one dimming control frame into a plurality of sub-frames, and splitting one sub-frame into a plurality of small sub-frames, can also be understood as temporally splitting the dimming control frame and the sub-frame, that is, displaying a plurality of sub-frames in the time occupied by the one dimming control frame, and displaying a plurality of small sub-frames in the time occupied by the one sub-frame.

Technical solutions of the present application and how the technical solutions of the present application solve the above-mentioned technical problem are described in detail below with specific embodiments. The following specific embodiments may be combined with each other, and same or similar concepts or processes may not be described in detail in some embodiments. The embodiments of the present application will be described below in combination with the drawings.

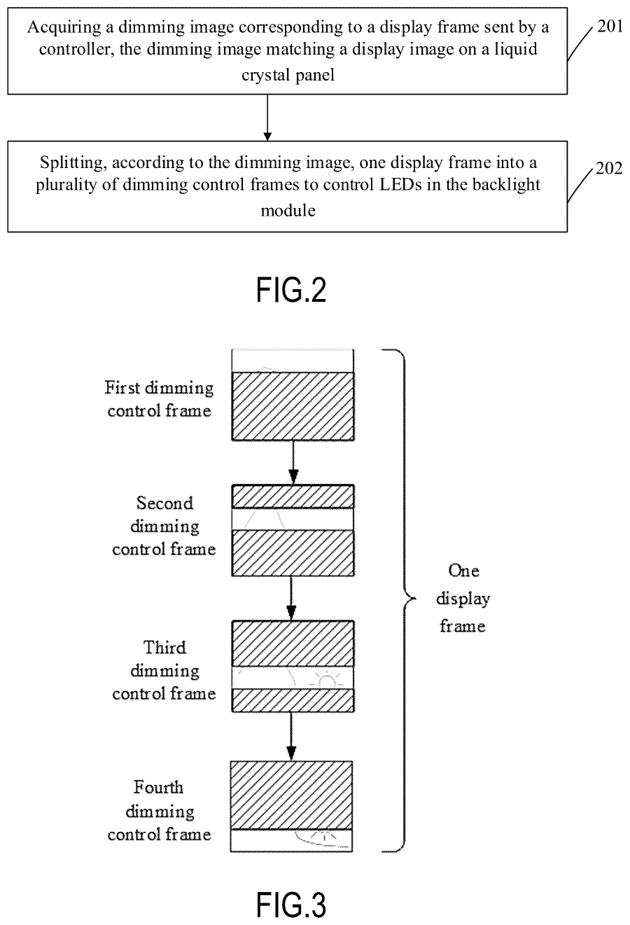

FIG. 2 is a flow diagram of a backlight control method provided in an embodiment of the present application. An executive subject of the method may be an LED driver. As shown in FIG. 2, the method includes:
Step 201, acquiring a dimming image corresponding to a display frame sent by a controller, the dimming image matching a display image on a liquid crystal panel.

In one embodiment, the controller may include a timing controller and/or an LED controller. A length of the display frame may be determined by a display frequency. For example, if a display frequency of a liquid crystal panel is 120 Hz, a length of one display frame may be 1/120 seconds.

In each display frame, the liquid crystal panel and a backlight module work together to provide display effects for the user. The display image and the dimming image (Local Dimming) may be used for display on the liquid crystal panel and the backlight module respectively. The display image may be a color image, and the dimming image may be a grayscale image. In one embodiment, a color display image may be converted into a grayscale image with reduced sharpness to obtain the dimming image.

It should be noted that grayscale values of various positions in the dimming image may be different, and thus when the dimming image is used to control LEDs in the backlight module, each LED may also have a different brightness.
Step 202: splitting, according to the dimming image, one display frame into a plurality of dimming control frames to control the LEDs in the backlight module.

An image corresponding to each dimming control frame is composed of a black image and a partial dimming image which are spliced, and in the plurality of dimming control frames, positions of black images move in a preset direction.

In one embodiment, assuming that a duration of one display frame is T, a duration of each dimming control frame may be T/4 after the one display frame is split into four dimming control frames. In the dimming control frame, an image displayed by the backlight module is obtained based on the dimming image by covering a part of the dimming image with a black image, and parts covered by black images are different in different dimming control frames of a same display frame. In the plurality of dimming control frames of the one display frame, the positions of the black images move in the preset direction.

The preset direction may be any direction such as a horizontal direction, a vertical direction, a diagonal direction, etc. In one embodiment, the preset direction is determined by a scanning direction of the liquid crystal panel. For example, if the liquid crystal panel is scanned from top to bottom, the positions of the black images in the image displayed by the backlight module may also move from top to bottom.

In an implementation, the backlight module may be divided into a plurality of horizontal areas, the plurality of horizontal areas are located at different heights, and a number of the plurality of horizontal areas is the same as a number of the dimming control frames split from the one display frame.

In an i-th dimming control frame, an i-th horizontal area is used for displaying a dimming image corresponding to the horizontal area, and remaining horizontal areas are used for displaying a black image; where i takes a value from 1 to n, and n is the number of the plurality of horizontal areas.

FIG. 3 is a display diagram during a backlight control process provided in an embodiment of the present application. As shown in FIG. 3, one display frame may be split into four dimming control frames. The backlight module includes LEDs in multiple rows and columns, which may be correspondingly divided into four horizontal areas, with each horizontal area including at least one row of LEDs. In the first to fourth dimming control frames, positions of black images are changed sequentially from top to bottom.

Specifically, in the first dimming control frame, a first horizontal area is used for displaying a dimming image corresponding to the horizontal area, and remaining horizontal areas are used for displaying a black image (the black image is represented by a shaded part in the figure); in the second dimming control frame, a second horizontal area is used for displaying a dimming image corresponding to the horizontal area, and remaining horizontal areas are used for displaying a black image; and so on, until display of the four dimming control frames is completed.

In another implementation, in an i-th dimming control frame, an i-th horizontal area is used for displaying a black image, and remaining horizontal areas are used for displaying a corresponding dimming image.

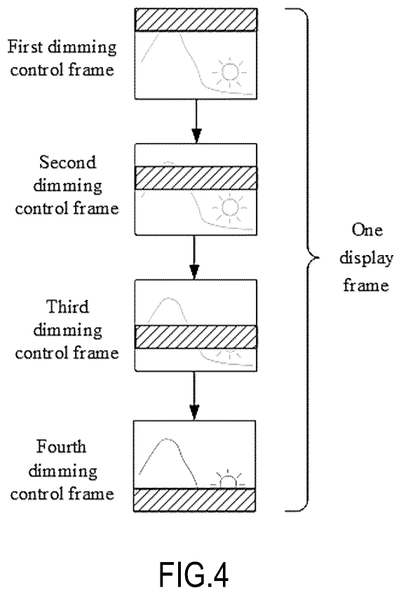

FIG. 4 is another display diagram of a backlight control process provided in an embodiment of the present application. As shown in FIG. 4, in the first dimming control frame, the first horizontal area is used for displaying a black image, and remaining horizontal areas are used for displaying a corresponding dimming image; in the second dimming control frame, the second horizontal area is used for displaying a black image, and remaining horizontal areas are used for displaying a corresponding dimming image; and so on, until display of the four dimming control frames is completed.

By dividing the backlight module into a plurality of horizontal areas and controlling, according to a dimming control frame, the plurality of horizontal areas to display an image composed of a black image and a dimming image which are spliced, positions of black images gradually changing along a scanning direction, black frame insertion effects can be matched with the scanning direction of a liquid crystal panel, thereby improving display effects.

In actual applications, when a frame of picture needs to be displayed, a controller may send a display image to a liquid crystal panel, and send a dimming image corresponding to the display image to an LED driver. The LED driver may split one display frame into a plurality of dimming control frames and partially insert a black image. In each dimming control frame, a position of a black image is controlled to change from top to bottom or from bottom to top. After the one display frame is completed, a next display frame is continuously received and a position of a black image continuously changes according to the same processing method.

According to the backlight control method provided in the present embodiment, it is possible to acquire a dimming image corresponding to a display frame sent by a controller, the dimming image matching a display image on a liquid crystal panel; and split, according to the dimming image, one display frame into a plurality of dimming control frames to control LEDs in a backlight module, so that control over the backlight module can be achieved at a higher frequency, and an amount of data for transmission can be effectively reduced with improved transmission efficiency. Moreover, an image corresponding to each dimming control frame is composed of a black image and a partial dimming image which are spliced, and in the plurality of dimming control frames, positions of black images move in a preset direction, which can alleviate the visual staying phenomenon and improve backlight effects.

On the basis of the technical solutions provided in the above embodiment, in one embodiment, the backlight module is controlled by a plurality of LED drivers through PWM signals; the splitting, according to the dimming image, the one display frame into the plurality of dimming control frames to control the LEDs in the backlight module may include: in each dimming control frame of the display frame, controlling a PWM signal of an LED driver corresponding to the dimming control frame to be turned off, and controlling PWM signals of remaining LED drivers to be turned on, to control, based on the turned-on PWM signals, a part of the LEDs in the backlight module to display a corresponding dimming image; where the LED driver corresponding to the dimming control frame is an LED driver corresponding to an area where a black image is located.

For example, after the backlight module is divided into the plurality of horizontal areas, a horizontal area may be controlled to display a partial dimming image or a black image by controlling an LED driver corresponding to the horizontal area to be turned on or off.

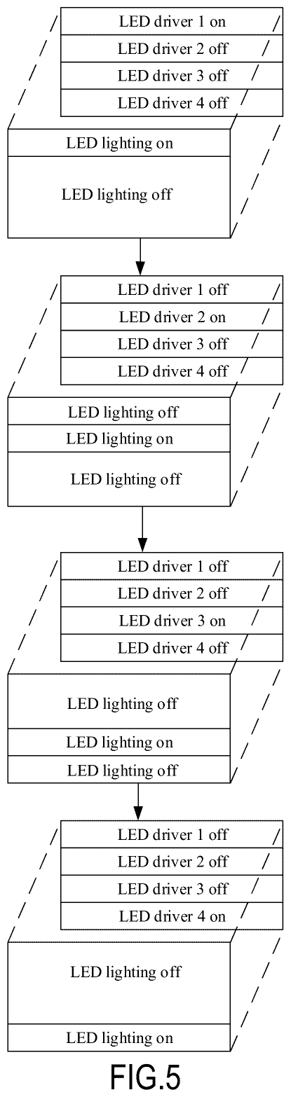

FIG. 5 is a control diagram of an LED driver provided in an embodiment of the present application. As shown in FIG. 5, which is corresponding to the solution shown in FIG. 3, in the first dimming control frame, an LED driver corresponding to a first horizontal area is turned on to control light-on for the first horizontal area and display a corresponding dimming image, and LED drivers corresponding to remaining horizontal areas are turned off, thus the remaining horizontal areas are lit off and are displayed in black (an black image is represented by a shaded part in the figure); in the second dimming control frame, a second LED driver is turned on to control light-on for a second horizontal area and display the corresponding dimming image, and LED drivers corresponding to remaining horizontal areas are turned off, so the remaining horizontal areas are lit off and are displayed in black; and so on, until display of the four dimming control frames is completed.

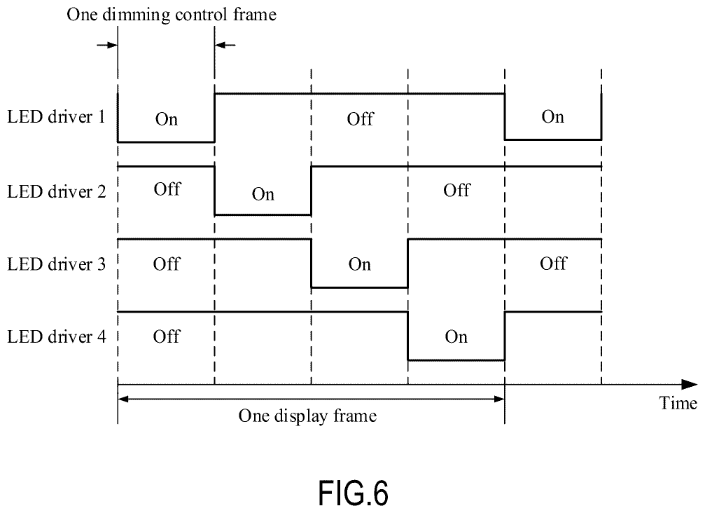

FIG. 6 is a timing diagram of an LED driver provided in an embodiment of the present application. As shown in FIG. 6, an LED driver 1 may be first controlled to be turned on, and remaining LED drivers may be turned off, so that there is a light-on for a corresponding horizontal area 1, and there is a light-off for remaining horizontal areas; then, an LED driver 2 may be controlled to be turned on, and remaining LED drivers may be turned off, so that there is a light-on for a corresponding horizontal area 2, and there is a light-off for remaining horizontal areas; and so on. As time changes, in the entire backlight module, the effect presented is that there is a sequential light-on for horizontal areas 1 to 4.

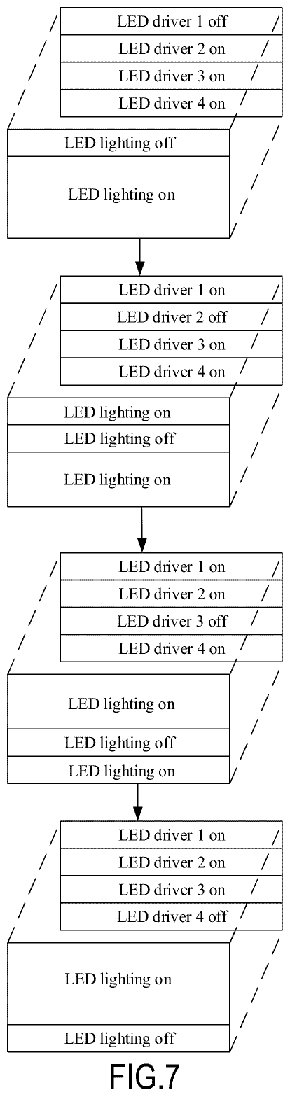

FIG. 7 is another control diagram of an LED driver provided in an embodiment of the present application. As shown in FIG. 7, which is corresponding to the solution shown in FIG. 4, in the first dimming control frame, an LED driver corresponding to a first horizontal area is turned off, thus the first horizontal area is lit off and displayed in black (an black image is represented by a shaded part in the figure), and LED drivers corresponding to remaining horizontal areas are turned on to control light-on of the remaining horizontal areas and display the dimming image; in the second dimming control frame, an LED driver corresponding to a second horizontal area is turned off, thus the second horizontal area is lit off and displayed in black, and LED drivers corresponding to remaining horizontal areas are turned on to control light-on of the remaining horizontal areas and display the dimming image; and so on, until display of the four dimming control frames is completed.

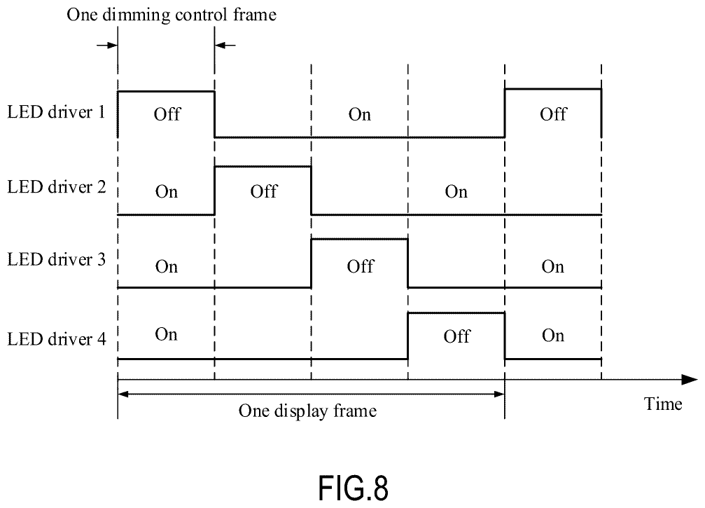

FIG. 8 is another timing diagram of an LED driver provided in an embodiment of the present application. As shown in FIG. 8, an LED driver 1 may be first controlled to be turned off, and remaining LED drivers may be turned on, so that there is a light-off for a corresponding horizontal area 1, and there is a light-on for remaining horizontal areas; then, an LED driver 2 may be controlled to be turned off, and remaining LED drivers may be turned on, so that there is a light-off for a corresponding horizontal area 2, and there is a light-on for remaining horizontal areas; and so on. As time changes, in the entire backlight module, the effect presented is that there is sequential light-off for horizontal areas 1 to 4.

In one embodiment, when a certain horizontal area is controlled to display in black, a corresponding LED driver may be controlled to be turned off, or, the LED driver may not be turned off and a PWM signal of the LED driver may be controlled to be turned off, that is, output of the PWM signal is stopped; and when a certain horizontal area displays a dimming image, a corresponding LED driver may be controlled to turn on the PWM signal.

A number of LED drivers may be the same as or different from a number of horizontal areas. Each horizontal area may be controlled by one LED driver, or each horizontal area may be controlled by a plurality of LED drivers, or one LED driver may control a plurality of horizontal areas, and different horizontal areas may be controlled through different channels.

Based on the technical solutions provided in the above embodiment, in one embodiment, each dimming control frame may be split into a plurality of sub-frames; where in each sub-frame, an image corresponding to the dimming control frame is displayed for a part of time, and an all-black image is displayed for a part of the time.

Taking FIG. 6 as an example, a stage in which an LED driver is turned on may be further split into a plurality of sub-frames, in which a dimming image and a black image are alternately displayed. For example, a duration of a stage in which an LED driver is turned on is t and is split into 5 sub-frames, each of which has a duration of t/5. A corresponding dimming image is displayed in the first half of each sub-frame, i.e., the anterior t/10, and a black image is displayed in the second half of each sub-frame, i.e., the posterior t/10.

In this way, in the first dimming control frame, an effect of alternately displaying a dimming image and a black image is presented in a horizontal area of a first row, while a black image is displayed in remaining horizontal areas. Thus, in the first dimming control frame, the entire backlight module has a display effect that a spliced image and an all-black image are alternately displayed, where the spliced image refers to an image composed of a dimming image and a black image which are spliced. Other dimming control frames are also split into a plurality of sub-frames to obtain a similar display effect, which is equivalent to inserting multiple frames of all-black images into each dimming control frame.

Similarly, in the solution shown in FIG. 8, each dimming control frame is split into a plurality of sub-frames, and finally an effect of inserting multiple frames of dimming images matching the display image into each dimming control frame can be obtained.

By splitting each dimming control frame into a plurality of sub-frames, it is possible to insert at least one enhancement frame into each dimming control frame, the enhancement frame being used for controlling the backlight module to display an all-black image or a dimming image matching the display image, thereby achieving high-frequency backlight control based on low-frequency data transmission and further improving display effects.

Based on the technical solutions provided in the above embodiment, in one embodiment, a number of sub-frames in each dimming control frame may be dynamically adjusted according to actual needs, and a sub-frame may be further split into small sub-frames to deal with a problem of abnormal backlight cycle. A total length of the small sub-frames may be smaller than a total length of the sub-frame.

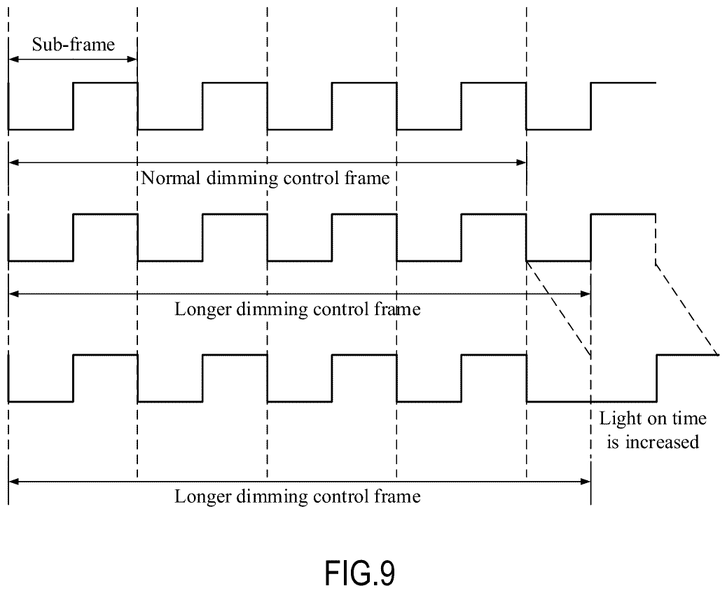

FIG. 9 is a diagram of an abnormal backlight cycle provided in an embodiment of the present application. As shown in FIG. 9, the first row is a normal dimming control frame including a plurality of sub-frames; and the second row is a dimming control frame with a longer period, and a corresponding duration thereof is greater than a duration of a normal dimming control frame. Since the duration of one dimming control frame is increased, an abnormal duty sub-frame will be generated when the dimming control frame is linked with a next dimming control frame, and the light on time will be increased.

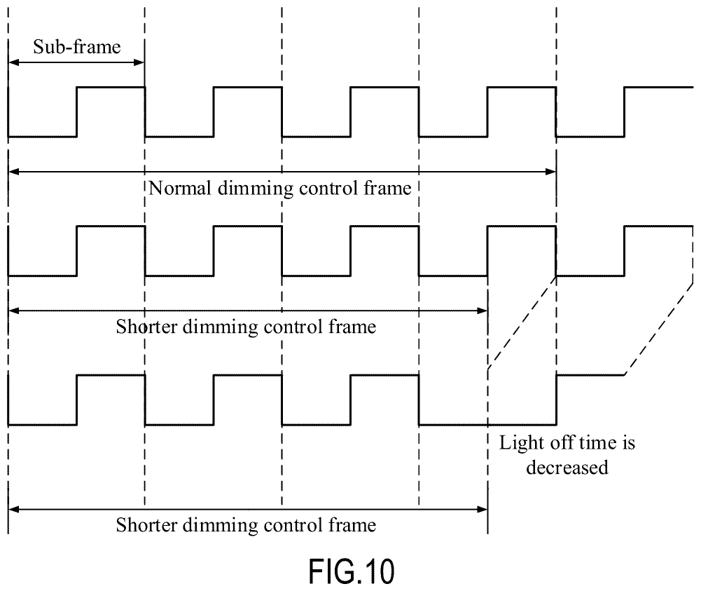

FIG. 10 is another diagram of an abnormal backlight cycle provided in an embodiment of the present application. As shown in FIG. 10, the first row is a normal dimming control frame including a plurality of sub-frames; and the second row is a dimming control frame with a shorter period, and a corresponding duration thereof is shorter than a duration of a normal dimming control frame. Since a duration of a dimming control frame is reduced, an abnormal duty sub-frame will be generated when the dimming control frame is linked with a next dimming control frame, and the light off time will be decreased.

Thus, there is a problem that when an input signal is not periodic and backlighting time is also not periodic, which may produce unnecessary brightness differences over time and eventually cause sudden backlight flashing.

In one embodiment, at least one most-latter sub-frame among the plurality of sub-frames may be split into a plurality of small sub-frames, and the small sub-frames are used for minimizing impacts of non-periodic input and reducing abnormal flashing.

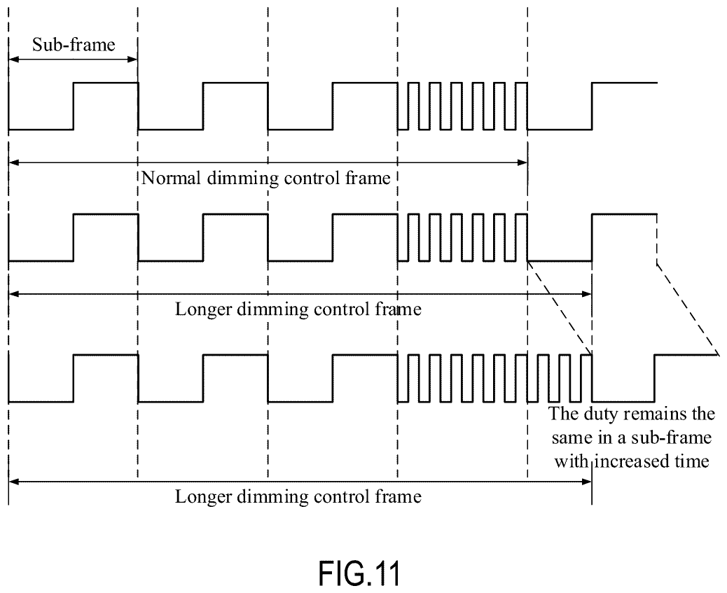

FIG. 11 is a diagram of setting a small sub-frame provided in an embodiment of the present application. As shown in FIG. 11, among the four sub-frames of one dimming control frame, the first three sub-frames may be retained, and the last sub-frame may be split into a plurality of small sub-frames. When a duration of the dimming control frame increases, a number of the small sub-frames finally obtained by splitting will also increase accordingly, and a duty may remain unchanged during an increased time period.

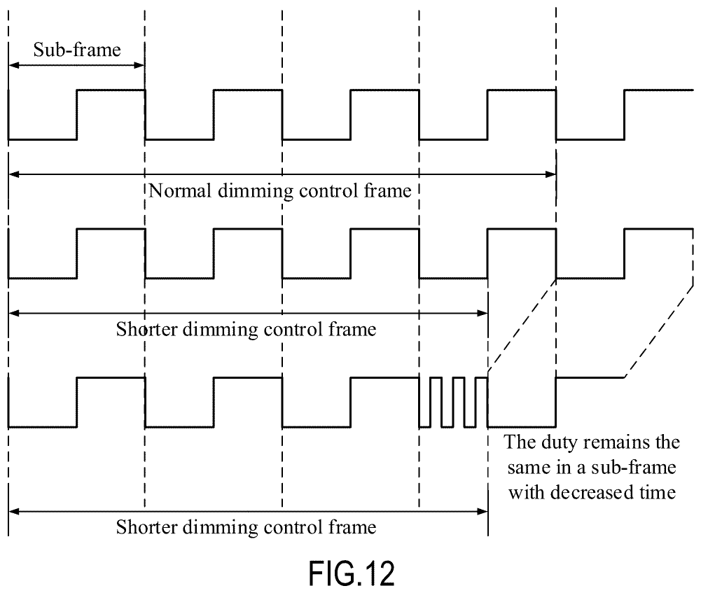

FIG. 12 is another diagram of setting a small sub-frame provided in an embodiment of the present application. As shown in FIG. 12, among the four sub-frames of one dimming control frame, the first three sub-frames may be retained, and the last sub-frame may be split into a plurality of small sub-frames. When a duration of the dimming control frame is reduced, a number of the small sub-frames finally obtained by splitting will also be reduced accordingly, and a duty may remain unchanged during a reduced time period.

In one embodiment, when it is detected that a frequency of an oscillator in the LED driver is abnormal or a speed of receiving data from a controller is abnormal, the at least one most-latter sub-frame among the plurality of sub-frames may be split into a plurality of small sub-frames.

Specifically, when a speed of inputting data is lower than a design speed, or the frequency of the oscillator in the LED driver is higher than a design frequency, frame time is increased; and when the speed of inputting data is higher than the design speed, or the frequency of the oscillator in the LED driver is lower than the design frequency, the frame time is reduced. By setting a small sub-frame, backlight flashing caused by changes in the speed of inputting data or a LED oscillator frequency can be reduced.

In one embodiment, in each dimming control frame, a number of sub-frames may be dynamically adjusted, and a number of sub-frames split into small sub-frames may also be dynamically adjusted.

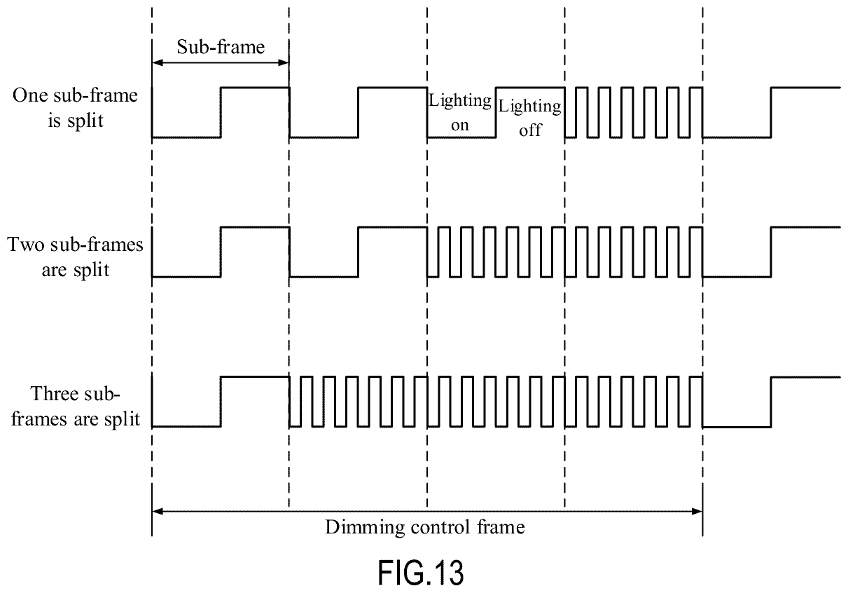

FIG. 13 is yet another diagram of setting a small sub-frame provided in an embodiment of the present application. As shown in FIG. 13, a number of small sub-frames is optional, and it is shown from top to bottom that in one dimming control frame, the last sub-frame is split, the last two sub-frames are split, and the last three sub-frames are split into small sub-frames.

Based on the technical solutions provided in the above embodiment, in one embodiment, a number of small sub-frames split from one sub-frame may be determined, and a resolution of a PWM signal corresponding to the small sub-frame may be determined according to the number of the small sub-frames from the splitting and a resolution of a PWM signal corresponding to the sub-frame. In one embodiment, the resolution corresponding to the small sub-frame may be smaller than the resolution corresponding to the sub-frame.

Specifically, in a small sub-frame, PWM precision may be different from that in a normal duty sub-frame. When sub-frame time becomes shorter, a pulse width of a PWM signal also becomes shorter. Thus, in order to ensure that a small sub-frame has an enough PWM width to light on an LED, a PWM resolution may be reduced.

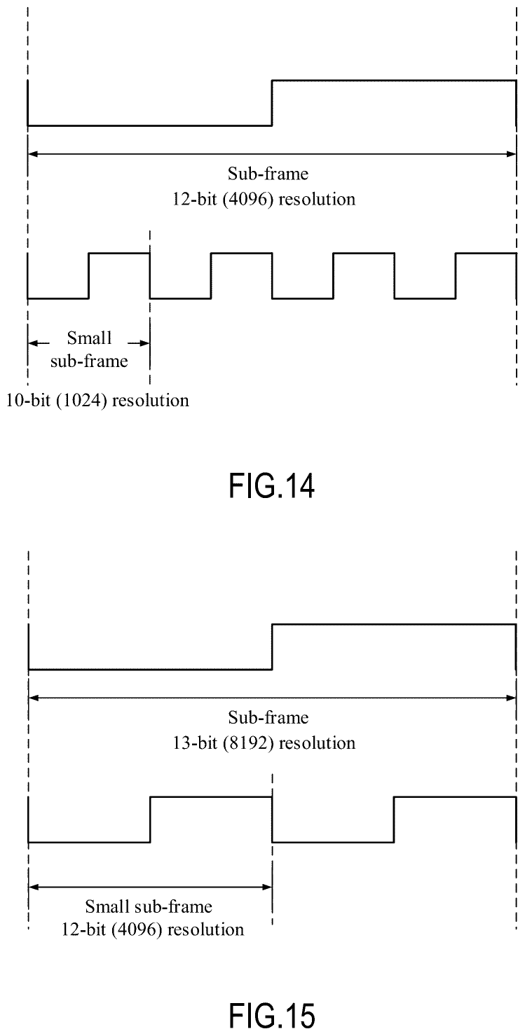

FIG. 14 is a diagram of resolutions of a sub-frame and a small sub-frame provided in an embodiment of the present application. As shown in FIG. 14, a solid line and a dotted line in the figure show various possible PWM signals corresponding to a sub-frame and a small sub-frame. A normal duty sub-frame may use a 12-bit resolution, corresponding to 4096 possible PWM signals; while a small sub-frame may use a 10-bit resolution, corresponding to 1024 possible PWM signals.

FIG. 15 is another diagram of resolutions of a sub-frame and a small sub-frame provided in an embodiment of the present application. As shown in FIG. 15, a normal duty sub-frame may use a 13-bit resolution, corresponding to 8192 possible PWM signals; while a small sub-frame may use a 12-bit resolution, corresponding to 4096 possible PWM signals.

In practical applications, it is possible to determine, according to a number of small sub-frames split from one sub-frame, a resolution of a PWM signal corresponding to the sub-frame and a resolution of a PWM signal corresponding to the small sub-frame. For example, if one sub-frame is split into 4 small sub-frames, the solution shown in FIG. 14 may be adopted; and if one sub-frame is split into 2 small sub-frames, the solution shown in FIG. 15 may be adopted.

By determining the resolution of the PWM signal corresponding to the small sub-frame according to the number of the small sub-frames from the splitting and the resolution of the PWM signal corresponding to the sub-frame, control of sub-frames and small sub-frames can be accurately realized, thereby improving control efficiency and accuracy.

Based on the technical solutions provided in the above embodiments, in one embodiment, the LED driver has a plurality of output channels, each output channel being used for controlling a plurality of LEDs; and the method further includes: determining phases of PWM signals of the output channels, where phases of output channels corresponding to a same horizontal area are different; and outputting the corresponding PWM signals through the plurality of output channels according to the determined phases to control LEDs in the backlight module.

Taking one LED driver being used to drive one horizontal area as an example, a plurality of output channels respectively drive LEDs at different positions in the horizontal area. The phases corresponding to the plurality of output channels are supposed to be the same, however, in the present embodiment, the plurality of output channels may be adjusted to have different phases.

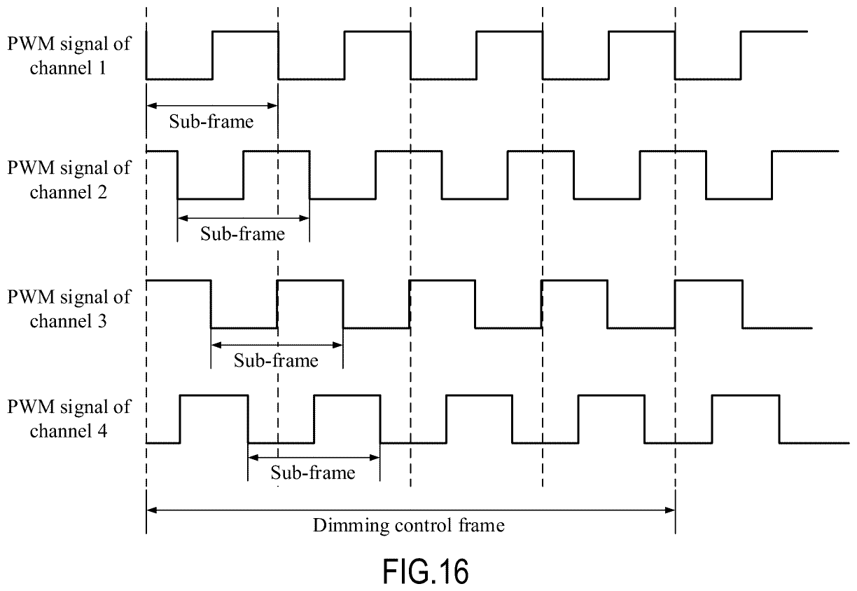

FIG. 16 is a diagram of a multi-channel output signal provided in an embodiment of the present application. As shown in FIG. 16, one LED driver may have four channels, and in one dimming control frame, phases of PWM signals output from the four channels may be different. In the embodiments of the present application, waveforms shown in FIG. 9 to FIG. 16 may all be PWM signals output by an LED driver.

In one embodiment, one horizontal area may correspond to a plurality of LED drivers, and output channels of the plurality of LED drivers may also be different. Alternatively, one LED driver may correspond to a plurality of horizontal areas, and for any horizontal area, phases of a plurality of output channels corresponding to the horizontal area may be different.

By changing phases of PWM pulses of a plurality of output channels of an LED driver, EMI (electromagnetic interference) can be effectively reduced and a control effect can be improved.

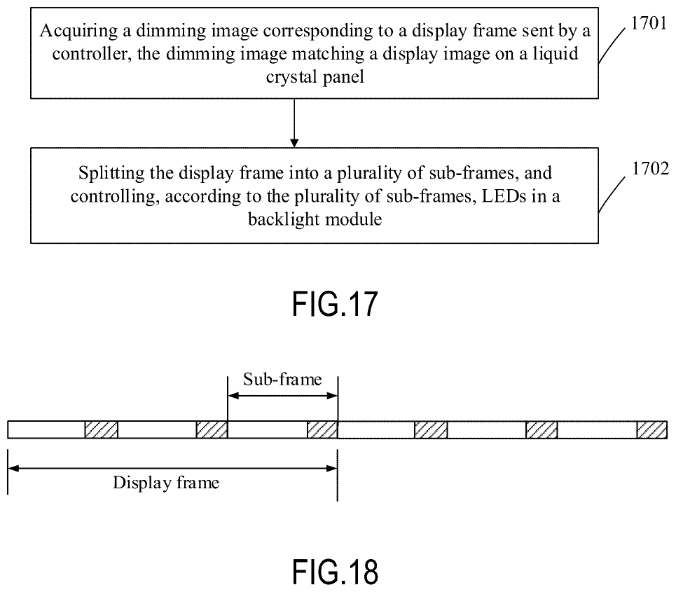

FIG. 17 is another flow diagram of a backlight control method provided in an embodiment of the present application. As shown in FIG. 17, the method may include:
Step 1701, acquiring a dimming image corresponding to a display frame sent by a controller, the dimming image matching a display image on a liquid crystal panel.

A specific implementation process of this step can be found in the above-mentioned embodiment and will not be repeated herein.
Step 1702, splitting the display frame into a plurality of sub-frames, and controlling, according to the plurality of sub-frames, LEDs in a backlight module.

In each sub-frame, the dimming image is displayed for a part of time, and an all-black image is displayed for a part of the time, which is equivalent to inserting the all-black image into the dimming image.

In one embodiment, the all-black image may refer to that brightness of all LEDs in the backlight module is 0.

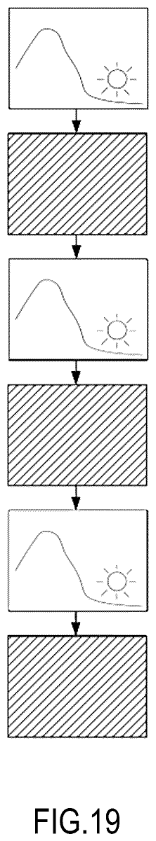

FIG. 18 is a timing diagram of inserting an all-black image provided in an embodiment of the present application. As shown in FIG. 18, one display frame may be split into a plurality of sub-frames, and each sub-frame may be composed of a dimming frame (blank part) and an all-black frame (shaded part), which are used for displaying a dimming image and an all-black image, respectively. FIG. 19 is a display diagram of a solution shown in FIG. 18. As shown in FIG. 19, after a plurality of all-black images are inserted into one display frame, the backlight module may alternately display an dimming image and an all-black image (black is represented by shading in the figure).

In one embodiment, at least one most-latter sub-frame among the plurality of sub-frames may be split into a plurality of small sub-frames. For example, when a frequency abnormality of an oscillator in the LED driver or a speed abnormality of receiving data from the controller is detected, the at least one most-latter sub-frame among the plurality of sub-frames is split into a plurality of small sub-frames; where a total length of the small sub-frames is smaller than a total length of the at least one most-latter sub-frame, and a number of the sub-frames split into small sub-frames is dynamically adjusted.

In one embodiment, a number of small sub-frames split from one sub-frame may also be determined; and resolutions of PWM signals corresponding to the small sub-frames are determined according to the number of the small sub-frames from the splitting and a resolution of a PWM signal corresponding to the sub-frame.

In one embodiment, an LED driver configured to drive the backlight module may have a plurality of output channels, each output channel being used for controlling a plurality of LEDs; and the method further includes: determining phases of PWM signals of the output channels, where phases of the output channels are different; and outputting, according to the determined phases, the corresponding PWM signals through the plurality of output channels.

Specific implementation principles, processes and effects of the backlight control method provided in the present embodiment can be found in the above-mentioned embodiments and will not be repeated herein.

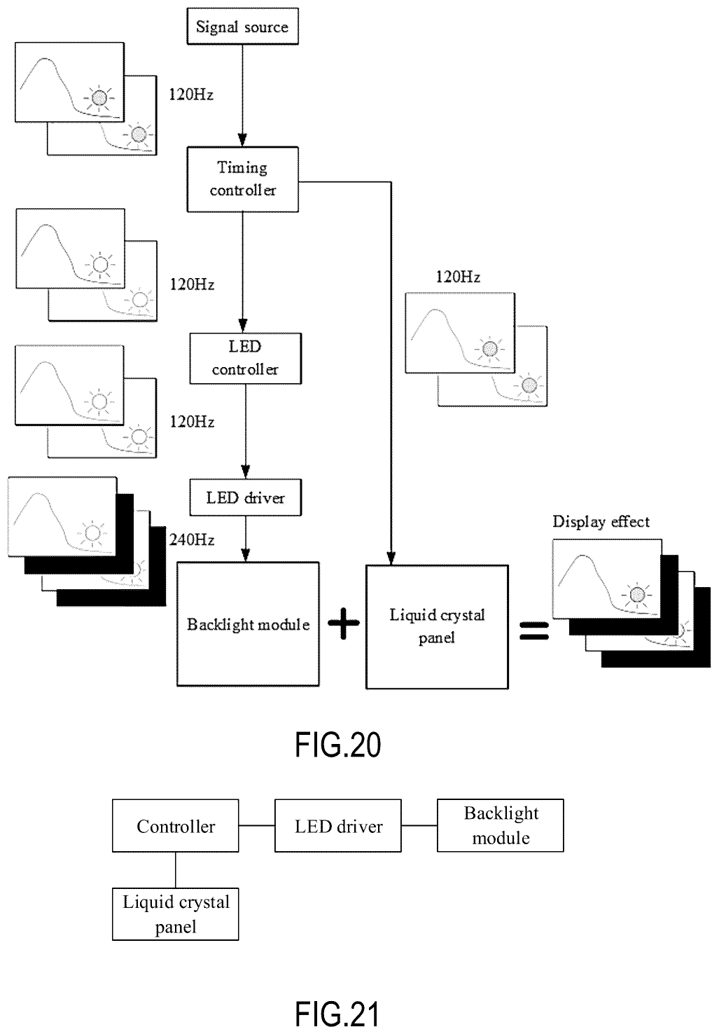

FIG. 20 is a diagram of a principle of backlight control provided in an embodiment of the present application. As shown in FIG. 20, in contrast to the technique shown in FIG. 1, the embodiments of the present application allow for increasing an output frequency of an LED driver by inserting a black image. The principle of FIG. 20 can be applicable to the method provided by any one of the above-mentioned embodiments.

Specifically, the timing controller may send a dimming image to an LED controller at a frequency of 120 Hz, and the LED controller may send the dimming image to an LED driver at a frequency of 120 Hz. The LED driver may adopt the method provided in any embodiment of the present application to insert an all-black image into the dimming image, or to generate a plurality of images obtained by splicing a black image and the dimming image, thereby obtaining a higher output frequency.

For example, in FIG. 20, an output frequency of an LED driver can be increased to 240 Hz by inserting an all-black image between two adjacent frames of dimming images. By inserting more all-black images, a higher output frequency can be obtained. Alternatively, a higher output frequency can be obtained by splitting one display frame into more dimming control frames. When an input frequency of the LED driver is 120 Hz, the output frequency may reach 240 Hz, 480 Hz, . . . , 3840 Hz, etc. In this way, the output frequency of the LED driver may not be equal to the input frequency of the LED driver, and the output frequency of the LED driver may be adjusted according to design requirements or user requirements, so that a high frequency control over the backlight module can be realized based on a low input frequency, thereby improving backlight effects while reducing an amount of data for transmission.

Corresponding to the above-mentioned backlight control method, an embodiment of the present application provides a backlight control apparatus, and the apparatus includes: a first acquiring module, configured to acquire a dimming image corresponding to a display frame sent by a controller, the dimming image matching a display image on a liquid crystal panel; and a first controlling module, configured to split, according to the dimming image, one display frame into a plurality of dimming control frames to control LEDs in a backlight module; where an image corresponding to each dimming control frame is composed of a black image and a partial dimming image which are spliced, and in the plurality of dimming control frames, positions of black images move in a preset direction.

In one embodiment, the backlight module is divided into a plurality of horizontal areas, and a number of the plurality of horizontal areas is the same as a number of the dimming control frames split from the one display frame; the preset direction is determined by a scanning direction of the liquid crystal panel; in an i-th dimming control frame, an i-th horizontal area is used for displaying a dimming image corresponding to the horizontal area, and remaining horizontal areas are used for displaying a black image; or, in an i-th dimming control frame, an i-th horizontal area is used for displaying a black image, and remaining horizontal areas are used for displaying a corresponding dimming image; where i takes a value from 1 to n, and n is the number of the plurality of horizontal areas.

In one embodiment, the backlight module is controlled by a plurality of LED drivers through PWM signals; and the first controlling module is specifically configured to: in each dimming control frame of the display frame, control a PWM signal of an LED driver corresponding to the dimming control frame to be turned off, and control PWM signals of remaining LED drivers to be turned on, to control, based on the turned-on PWM signals, a part of LEDs in the backlight module to display the corresponding dimming image; where the LED driver corresponding to the dimming control frame is an LED driver corresponding to an area where a black image is located.

In one embodiment, the first controlling module is further configured to: split each dimming control frame into a plurality of sub-frames; where in each sub-frame, an image corresponding to the dimming control frame is displayed for a part of time, and an all-black image is displayed for a part of the time.

In one embodiment, the first controlling module is further configured to: when a frequency abnormality of an oscillator in the LED driver or a speed abnormality of receiving data from the controller is detected, split at least one most-latter sub-frame among the plurality of sub-frames into a plurality of small sub-frames; where a total length of the small sub-frames is smaller than a total length of the at least one most-latter sub-frame, and a number of sub-frames split into small sub-frames is dynamically adjusted.

In one embodiment, the first controlling module is further configured to: determine a number of small sub-frames split from one sub-frame; and determine, according to the number of the small sub-frames from the splitting and a resolution of a PWM signal corresponding to the sub-frame, resolutions of PWM signals corresponding to the small sub-frames.

In one embodiment, the LED driver has a plurality of output channels, each output channel being used for controlling a plurality of LEDs; and the first controlling module is further configured to: determine phases of PWM signals of the output channels, where phases of output channels corresponding to a same horizontal area are different; and output, according to the determined phases, the corresponding PWM signals through the plurality of output channels.

An embodiment of the present application further provides a backlight control apparatus, and the apparatus may include: a second acquiring module, configured to acquire a dimming image corresponding to a display frame sent by a controller, the dimming image matching a display image on a liquid crystal panel; and a second controlling module, configured to split the display frame into a plurality of sub-frames, and control, according to the plurality of sub-frames, LEDs in a backlight module; where in each sub-frame, the dimming image is displayed for a part of time, and an all-black image is displayed for a part of the time.

Specific implementation principles, processes and effects of the backlight control apparatuses provided in the embodiments of the present application can be found in the above-mentioned embodiments and will not be repeated herein.

An embodiment of the present application further provides an LED driver, including: a memory and at least one processor; where the memory stores an computer executable instruction; and the at least one processor executes the computer executable instruction stored in the memory, to cause the at least one processor to execute the method described in any one of the above-mentioned embodiments.

FIG. 21 is a structural diagram of an electronic device provided in an embodiment of the present application. As shown in FIG. 21, the electronic device may include: an LED driver, a controller, a backlight module and a liquid crystal panel; where the controller is connected to the LED driver, and is configured to determine, according to a display image corresponding to the liquid crystal panel, a corresponding dimming image and send the corresponding dimming image to the LED driver; the backlight module is connected to the LED driver, and is configured to provide backlight brightness for the liquid crystal panel under control of the LED driver; the liquid crystal panel is connected to the controller, and is configured to acquire the display image and display the display image; and the LED driver is configured to execute the method described in any one of the above-mentioned embodiments.

Structures, functions, connection relationships, and specific implementation principles, processes, and effects of various components in the electronic device provided in the present embodiment can be found in the above-mentioned embodiments and will not be repeated herein.

An embodiment of the present application further provides a computer readable storage medium, the computer readable storage medium storing a computer executable instruction, where when the computer executable instruction is executed by a processor, the backlight control method described in any one of the above-mentioned embodiments is implemented.

An embodiment of the present application further provides a computer program product including a computer program, where when the computer program is executed by a processor, the method described in any one of the above-mentioned embodiments is implemented.

In several embodiments provided in the present application, it should be understood that the disclosed devices and methods may be implemented in other ways. For example, the device embodiments described above are merely illustrative, for example, division of the modules is merely a logical function division, and there may be other division methods in an actual implementation, for example, a plurality of modules may be combined or integrated into another system, or some features may be ignored or not executed. Another point is that the mutual coupling or direct coupling or communication connection shown or discussed may be indirect coupling or communication connection through some interfaces, apparatuses or modules, which may be electrical, mechanical or other forms.

The modules described as separate components may or may not be physically separated, and components shown as modules may or may not be physical units, that is, the components may be located in one place or distributed on a plurality of network units. Some or all of the modules may be selected according to actual needs to implement solutions of the present embodiment.

In addition, various functional modules in various embodiments of the present application may be integrated in a processing unit, or each module may physically exist separately, or two or more modules may be integrated in one unit. A unit in which the above-mentioned modules are integrated may be implemented in a form of hardware or in a form of hardware plus software functional units.

The above-mentioned integrated modules implemented in a form of a software function module may be stored in a computer readable storage medium. The above-mentioned software function module is stored in a storage medium, including a number of instructions for enabling a computer device (which may be a personal computer, a server, or a network device, etc.) or a processor to execute some steps of the methods described in various embodiments of the present application.

It should be understood that the above-mentioned processor may be a central processing unit (CPU), or other general purpose processors, digital signal processors (DSPs), application specific integrated circuits (ASICs), etc. A general purpose processor may be a microprocessor, or the processor may be any conventional processor, etc. Steps of the method disclosed in the present invention may be directly embodied as being executed by a hardware processor, or may be executed by a combination of hardware and a software module in a processor.

A memory may include a high-speed random access memory (RAM) memory, and may also include a non-volatile memory (NVM), for example, at least one disk memory, and may also be a universal serial bus (USB) flash drive, a mobile hard disk, a read only memory, a magnetic disk or an optical disk, etc. A bus may be an industry standard architecture (ISA) bus, a peripheral component interconnect (PCI) bus, or an extended industry standard architecture (EISA) bus, etc. A bus may be categorized as an address bus, a data bus, a control bus, etc. For ease of representation, buses in the drawings of the present application are not limited to only one bus or one type of bus.

The above-mentioned storage medium may be implemented by any type of volatile or non-volatile storage device or a combination thereof, for example, a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk. A storage medium may be any available medium which can be accessed by a general purpose or dedicated computer.

An exemplary storage medium is coupled to a processor, so that the processor can read information from, and write information to, the storage medium. Certainly, a storage medium may also be a constituent part of a processor. A processor and a storage medium may be located in an application specific integrated circuit (ASIC). Certainly, a processor and a storage medium may also exist as separated components in an electronic device or a main control device.

A person of ordinary skill in the art may understand that: all or some of steps for implementing each of the above-mentioned method embodiments may be accomplished by hardware associated with a program instruction. The aforementioned program may be stored in a computer readable storage medium. When the program is executed, steps of the above-mentioned method embodiments are executed; and the aforementioned storage medium includes: an ROM, an RAM, a magnetic disk or an optical disk and other media which can store program codes.

According to the backlight control method, the device and the storage medium provided in the embodiments of the present application, it is possible to acquire a dimming image corresponding to a display frame sent by a controller, the dimming image matching a display image on a liquid crystal panel; and split, according to the dimming image, one display frame into a plurality of dimming control frames to control LEDs in a backlight module, so that control over the backlight module can be achieved at a higher frequency, and an amount of data for transmission can be effectively reduced with improved transmission efficiency. Moreover, an image corresponding to each dimming control frame is composed of a black image and a partial dimming image which are spliced, and in the plurality of dimming control frames, positions of black images move in a preset direction, so that the visual staying phenomenon can be alleviated to improve backlight effects.

Finally, it should be noted that: the above embodiments are only used to illustrate the technical solutions of the present application, rather than to limit the technical solutions of the present application. Although the present application has been described in detail with reference to the aforementioned embodiments, persons of ordinary skill in the art should understand that: they can still modify the technical solutions described in the aforementioned embodiments, or replace some or all of the technical features therein equivalently. However, these modifications or replacements do not cause the essence of corresponding technical solutions to deviate from the scope of the technical solutions in the embodiments of the present application.

What is claimed is:

1. A backlight control method, comprising:
acquiring a dimming image corresponding to a display frame sent by a controller, the dimming image matching a display image on a liquid crystal panel; and
splitting, according to the dimming image, one display frame into a plurality of dimming control frames to control light emitting diodes (LEDs) in a backlight module;
wherein an image corresponding to each dimming control frame is composed of a black image and a partial dimming image which are spliced, and in the plurality of dimming control frames, positions of black images move in a preset direction.

2. The method according to claim 1, wherein the backlight module is divided into a plurality of horizontal areas, and a number of the plurality of horizontal areas is the same as a number of the dimming control frames split from the one display frame; the preset direction is determined by a scanning direction of the liquid crystal panel;
in an i-th dimming control frame, an i-th horizontal area is used for displaying a dimming image corresponding to the horizontal area, and remaining horizontal areas are used for displaying a black image; or, in an i-th dimming control frame, an i-th horizontal area is used for displaying a black image, and remaining horizontal areas are used for displaying a corresponding dimming image;
wherein i takes a value from 1 to n, and n is the number of the plurality of horizontal areas.

3. The method according to claim 2, wherein the backlight module is controlled by a plurality of LED drivers through pulse width modulation (PWM) signals; and the splitting, according to the dimming image, the one display frame into the plurality of dimming control frames to control the LEDs in the backlight module, comprises:
in each dimming control frame of the display frame, controlling a PWM signal of an LED driver corresponding to the dimming control frame to be turned off, and controlling PWM signals of remaining LED drivers to be turned on, to control, based on the turned-on PWM signals, a part of the LEDs in the backlight module to display a corresponding dimming image;
wherein the LED driver corresponding to the dimming control frame is an LED driver corresponding to an area in which a black image is located.

4. The method according to claim 3, further comprising:
splitting each dimming control frame into a plurality of sub-frames; wherein in each sub-frame, an image corresponding to the dimming control frame is displayed for a part of time, and an all-black image is displayed for a part of the time.

5. The method according to claim 4, further comprising:
when a frequency abnormality of an oscillator in the LED driver or a speed abnormality of receiving data from the controller is detected, splitting at least one most-latter sub-frame among the plurality of sub-frames into a plurality of small sub-frames;
wherein a total length of the small sub-frames is smaller than a total length of the at least one most-latter sub-frame, and a number of sub-frames split into small sub-frames is dynamically adjusted.

6. The method according to claim 5, further comprising:
determining a number of small sub-frames split from one sub-frame; and
determining, according to the number of the small sub-frames from the splitting and a resolution of a PWM signal corresponding to the sub-frame, resolutions of PWM signals corresponding to the small sub-frames.

7. The method according to claim 3, wherein the LED driver has a plurality of output channels, each output channel being used for controlling a plurality of LEDs; and the method further comprises:
determining phases of PWM signals of the output channels, wherein phases of output channels corresponding to a same horizontal area are different; and
outputting, according to the determined phases, the corresponding PWM signals through the plurality of output channels.

8. A backlight control method, comprising:
acquiring a dimming image corresponding to a display frame sent by a controller, the dimming image matching a display image on a liquid crystal panel;
splitting the display frame into a plurality of sub-frames, and controlling, according to the plurality of sub-frames, light emitting diodes (LEDs) in a backlight module; wherein in each sub-frame, the dimming image is displayed for a part of time, and an all-black image is displayed for a part of the time.

9. A backlight control apparatus, comprising:
a memory and at least one processor;
wherein the memory stores an computer executable instruction; and the at least one processor executes the computer executable instruction stored in the memory, to cause the at least one processor to:
acquire a dimming image corresponding to a display frame sent by a controller, the dimming image matching a display image on a liquid crystal panel; and
split, according to the dimming image, one display frame into a plurality of dimming control frames to control light emitting diodes (LEDs) in a backlight module;
wherein an image corresponding to each dimming control frame is composed of a black image and a partial dimming image which are spliced, and in the plurality of dimming control frames, positions of black images move in a preset direction.

10. The apparatus according to claim 9, wherein the backlight module is divided into a plurality of horizontal areas, and a number of the plurality of horizontal areas is the same as a number of the dimming control frames split from the one display frame; the preset direction is determined by a scanning direction of the liquid crystal panel;
in an i-th dimming control frame, an i-th horizontal area is used for displaying a dimming image corresponding to the horizontal area, and remaining horizontal areas are used for displaying a black image; or, in an i-th dimming control frame, an i-th horizontal area is used for displaying a black image, and remaining horizontal areas are used for displaying a corresponding dimming image;
wherein i takes a value from 1 to n, and n is the number of the plurality of horizontal areas.

11. The apparatus according to claim 10, wherein the backlight module is controlled by a plurality of LED drivers through pulse width modulation (PWM) signals; and the at least one processor is further caused to:
in each dimming control frame of the display frame, control a PWM signal of an LED driver corresponding to the dimming control frame to be turned off, and control PWM signals of remaining LED drivers to be turned on, to control, based on the turned-on PWM signals, a part of the LEDs in the backlight module to display a corresponding dimming image;
wherein the LED driver corresponding to the dimming control frame is an LED driver corresponding to an area in which a black image is located.

12. The apparatus according to claim 11, wherein the at least one processor is further caused to:
split each dimming control frame into a plurality of sub-frames; wherein in each sub-frame, an image corresponding to the dimming control frame is displayed for a part of time, and an all-black image is displayed for a part of the time.

13. The apparatus according to claim 12, wherein the at least one processor is further caused to:
when a frequency abnormality of an oscillator in the LED driver or a speed abnormality of receiving data from the controller is detected, split at least one most-latter sub-frame among the plurality of sub-frames into a plurality of small sub-frames;
wherein a total length of the small sub-frames is smaller than a total length of the at least one most-latter sub-frame, and a number of sub-frames split into small sub-frames is dynamically adjusted.

14. The apparatus according to claim 13, wherein the at least one processor is further caused to:
determine a number of small sub-frames split from one sub-frame; and
determine, according to the number of the small sub-frames from the splitting and a resolution of a PWM signal corresponding to the sub-frame, resolutions of PWM signals corresponding to the small sub-frames.

15. The apparatus according to claim 11, wherein the LED driver has a plurality of output channels, each output channel being used for controlling a plurality of LEDs; and the at least one processor is further caused to:
determine phases of PWM signals of the output channels, wherein phases of output channels corresponding to a same horizontal area are different; and
output, according to the determined phases, the corresponding PWM signals through the plurality of output channels.

16. A backlight control apparatus, comprising:
a memory and at least one processor;
wherein the memory stores an computer executable instruction; and the at least one processor executes the computer executable instruction stored in the memory, to cause the at least one processor to execute the method according to claim 8.

17. An electronic device, comprising a light emitting diode (LED) driver, a controller, a backlight module and a liquid crystal panel;
wherein the controller is connected to the LED driver, and is configured to determine, according to a display image corresponding to the liquid crystal panel, a corresponding dimming image and send the corresponding dimming image to the LED driver;
the backlight module is connected to the LED driver, and is configured to provide backlight brightness for the liquid crystal panel under control of the LED driver;
the liquid crystal panel is connected to the controller, and is configured to acquire the display image from the controller and display the display image; and
the LED driver is configured to execute the method according to claim 1.

18. An electronic device, comprising a light emitting diode (LED) driver, a controller, a backlight module and a liquid crystal panel;
wherein the controller is connected to the LED driver, and is configured to determine, according to a display image corresponding to the liquid crystal panel, a corresponding dimming image and send the corresponding dimming image to the LED driver;
the backlight module is connected to the LED driver, and is configured to provide backlight brightness for the liquid crystal panel under control of the LED driver;
the liquid crystal panel is connected to the controller, and is configured to acquire the display image from the controller and display the display image; and
the LED driver is configured to execute the method according to claim 8.

19. A non-transitory computer readable storage medium storing a computer executable instruction, wherein when the computer executable instruction is executed by a processor, the method according to claim 1 is implemented.

20. A non-transitory computer readable storage medium storing a computer executable instruction, wherein when the computer executable instruction is executed by a processor, the method according to claim 8 is implemented.
